(19) United States
(12) Patent Application Publication
(10) Pub. No.: US 2012/0146474 A1
(43) Pub. Date: Jun. 14, 2012

(54) POSITIONING BASE WITH ADJUSTABLE SUPPORT LEVELERS FOR A HOUSEHOLD APPLIANCE

(75) Inventor: James O'Neal Taylor, Jacksboro, TN (US)

(73) Assignee: BSH HOME APPLIANCES CORPORATION, Huntington Beach, CA (US)

(21) Appl. No.: 12/967,170

(22) Filed: Dec. 14, 2010

(51) Int. Cl. A47B 88/04; F16M 13/00

(52) U.S. Cl. 312/334.4; 248/346.05

(57) ABSTRACT

A positioning base for locating a household appliance in a cabinet is provided. The base has a main body for attaching to a support area of the cabinet; an elevated section attached to the main body, an upper surface of the elevated section being located above the main body; and a plurality of adjustable levelers attached to the upper surface. Each adjustable leveler has a head for supporting the household appliance, and an adjustment portion fixed to the head and movable relative to the upper surface of the elevated section such that movement of the adjustment portion moves the head vertically relative to the upper surface of the elevated section. The head of each of the adjustable levelers provides a resting point for a support point on the household appliance, and each adjustable leveler is adjustable independently of each of the other adjustable levelers.

### FIELD OF THE INVENTION

The invention is directed to a positioning base for a household appliance, and, more particularly, to a positioning base having adjustable support levelers.

An example of an application for the invention is a positioning base for a cabinet mounted household oven.

### BACKGROUND OF THE INVENTION

Many home appliances, such as, for example, ovens, are mounted in cabinets or other structures. Many of these cabinets or other structures are high quality, visually pleasing and expensive. It can be difficult and time consuming to position a household appliance such as an oven in a built-in installation using conventional mounting and positioning systems. Often the support surface (such as a shelf) on which the appliance is positioned is not level and/or is not parallel/perpendicular to the edges of the cabinet that are visible after the installation is complete. This leads to either unsightly alignment or a difficult alignment process that can be time consuming.

Some appliances that are designed to be built-in to a cabinet do not have any leveling system as a part of the appliance. Installing such appliances often involves using shims of different thicknesses between the appliance and the support surface of the cabinet in order to properly position the appliance relative to the cabinet. This process can require repeatedly placing shims in the cabinet, placing the appliance in the cabinet, removing the appliance from the cabinet, repositioning/replacing the shims, and replacing the appliance in the cabinet.

### SUMMARY

The invention recognizes that it is desirable to provide a positioning system that is easy to install and that facilitates the proper positioning of an appliance in a cabinet or other structure. Exemplary embodiments of the invention provide a positioning base that has adjustable levelers that support the appliance above a support surface of the cabinet or structure.

In particular embodiments, a positioning base has four adjustable support levelers that are independently height adjustable in order to provide four points of contact between the support surface of the cabinet and the appliance.

Particular embodiments of the invention are directed to a positioning base for locating a household appliance in a cabinet. The base has a main body for attaching to a support area of the cabinet; a first elevated section attached to the main body, an upper surface of the first elevated section being located vertically above the main body when the base is attached to the cabinet; and a plurality of adjustable levelers attached to the upper surface of the first elevated section. Each adjustable leveler has a head for supporting the household appliance, and an adjustment portion fixed to the head and movable relative to the upper surface of the first elevated section such that movement of the adjustment portion moves the head vertically relative to the upper surface of the first elevated section. The head of each of the adjustable levelers provides a resting point for a support point on the household appliance, and each adjustable leveler is adjustable independently of each of the other adjustable levelers.

Other embodiments of the invention are directed to a cabinet for containing a household appliance, the cabinet has a cabinet body having an appliance receiving area; and a positioning base positioned in the receiving area for locating the household appliance in the cabinet. The base has a main body attached to a support area of the appliance receiving area; a first elevated section attached to the main body, an upper surface of the first elevated section being located vertically above the main body; and a plurality of adjustable levelers attached to the upper surface of the first elevated section. Each adjustable leveler has a head for supporting the household appliance, and an adjustment portion fixed to the head and movable relative to the upper surface of the first elevated section such that movement of the adjustment portion moves the head vertically relative to the upper surface of the first elevated section. The head of each of the adjustable levelers provides a resting point for a support point on the household appliance, and each adjustable leveler is adjustable independently of each of the other adjustable levelers.

Other embodiments of the invention are directed to a cabinet/appliance combination that includes a household appliance; and a cabinet. The cabinet has a cabinet body having an appliance receiving area; and a positioning base positioned in the receiving area, the base locating the household appliance in the cabinet. The base has a main body attached to a support area of the appliance receiving area; a first elevated section attached to the main body, an upper surface of the first elevated section being located vertically above the main body; and a plurality of adjustable levelers attached to the upper surface of the first elevated section. Each adjustable leveler has a head for supporting the household appliance, and an adjustment portion fixed to the head and movable relative to the upper surface of the first elevated section such that movement of the adjustment portion moves the head vertically relative to the upper surface of the first elevated section. The head of each of the adjustable levelers provides a resting point that supports a support point on the household appliance, and each adjustable leveler is adjustable independently of each of the other adjustable levelers.

### BRIEF DESCRIPTION OF THE DRAWINGS

The following figures form part of the present specification and are included to further demonstrate certain aspects of the disclosed features and functions, and should not be used to limit or define the disclosed features and functions. Consequently, a more complete understanding of the exemplary embodiments and further features and advantages thereof may be acquired by referring to the following description taken in conjunction with the accompanying drawings, wherein:

FIG. 1 is a perspective view of a cabinet and positioning base in accordance with an exemplary embodiment of the invention;

FIG. 2 is a front view of a positioning base in accordance with an exemplary embodiment of the invention;

FIG. 3 is a top view of a positioning base in accordance with an exemplary embodiment of the invention;

FIG. 4 is a magnified view of the area encircled in FIG. 2;

FIG. 5 is a magnified view of the area encircled in FIG. 3; and

FIG. 6 is a perspective view of an appliance/cabinet combination in accordance with an exemplary embodiment of the invention.

### DETAILED DESCRIPTION

The invention is described herein with reference to the accompanying drawings in which exemplary embodiments of the invention are shown. The invention may, however, be embodied in many different forms and should not be construed as limited to the embodiments set forth herein.

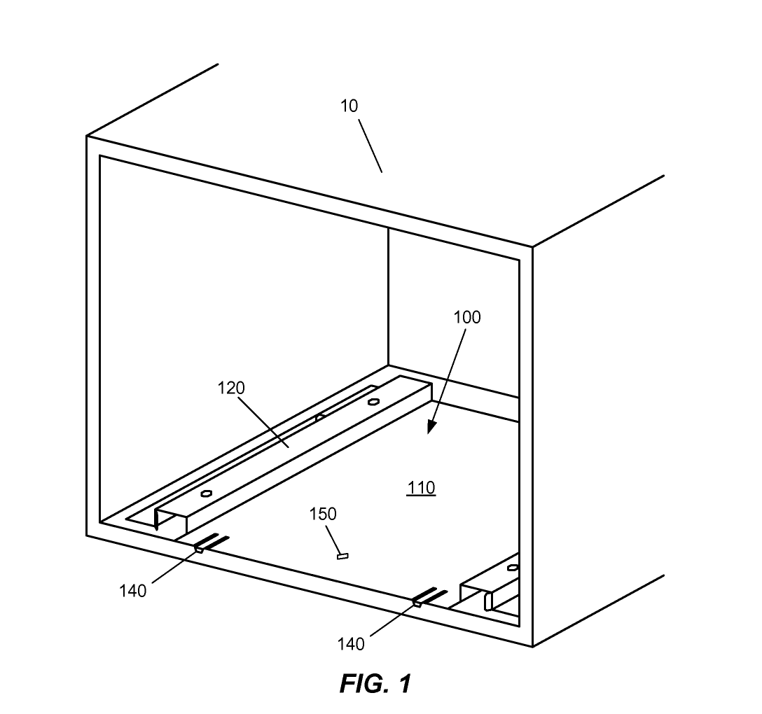

FIG. 1 shows a cabinet 10 having an internal space that can be occupied by a household appliance. FIG. 1 shows a positioning base 100 located in the internal space of cabinet 10. Positioning base 100 has several locating features that assist in properly locating positioning base 100 in cabinet 10. In this example, positioning base 100 has two edge guides 140 at its front edge which overhang a front edge of a support surface, or shelf, of cabinet 10. Positioning base 100 is pushed rearwardly into the internal space of cabinet 10 until edge guides 140 contact the front edge of the support surface or cabinet. In this example, positioning base 100 also has two locating diamonds 150 that are holes in a main body 110 of positioning base 100. A center line can be drawn on the support surface, or shelf, of cabinet 10 prior to inserting positioning base 100 into cabinet 10. The center line can be seen through locating diamonds 150 and positioning base 100 can be moved until the center line is centered in locating diamonds 150. Positioning base 100 has two elevated sections 120 that are elevated above the support surface or shelf.

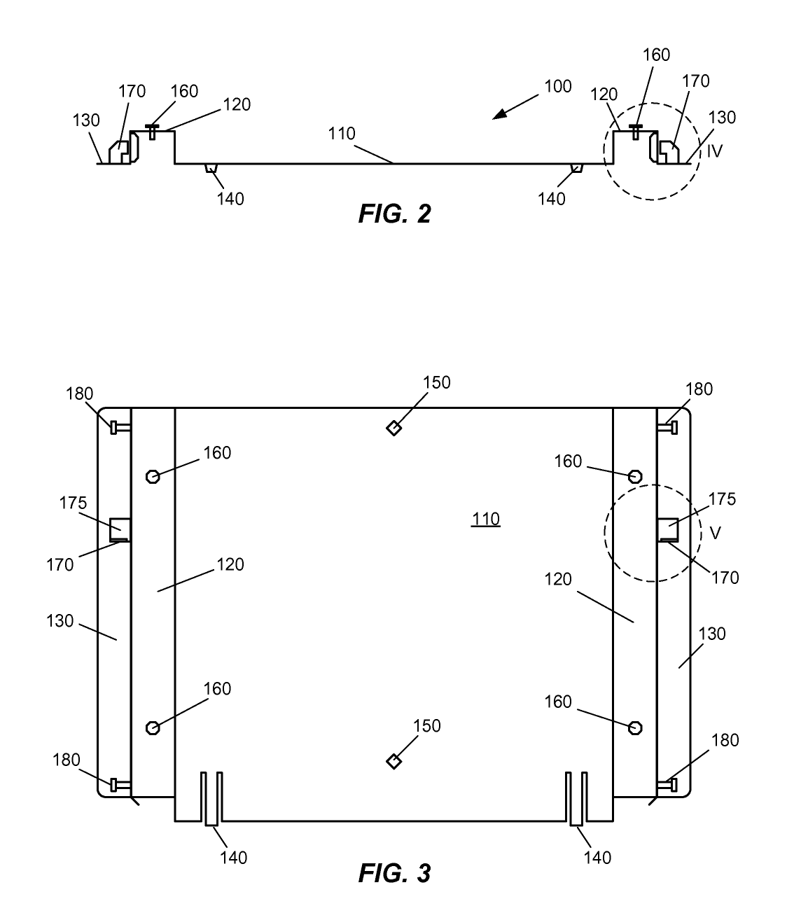

FIGS. 2 and 3 show a front view and a top view, respectively, of positioning base 100. In this embodiment, positioning base 100 is formed from a single sheet of material such as, for example, stainless steel. Positioning base 100 has a flat main body 110 and side sections 130 that are designed to sit flat on a support surface, or shelf, of cabinet 10. Elevated sections 120 extend upwardly from main body 110. A plurality, in this example four, adjustable levelers 160 are positioned in elevated sections 120. The purpose of adjustable levelers 160 is to provide contact points at which an appliance can rest on positioning base 100. The operation of adjustable levelers 160 will be discussed further below.

Also shown in FIG. 3 are four projections 180 that project outwardly from the sides of elevated sections 120. Projections 180 are omitted from FIG. 2 so as not to obscure other features in the figure. Projections 180 provide engagement points for rails that can be mounted to the appliance that is to be positioned on positioning base 100. Also shown in the figures are two rail catches 170 that interact with rails mounted to the appliance.

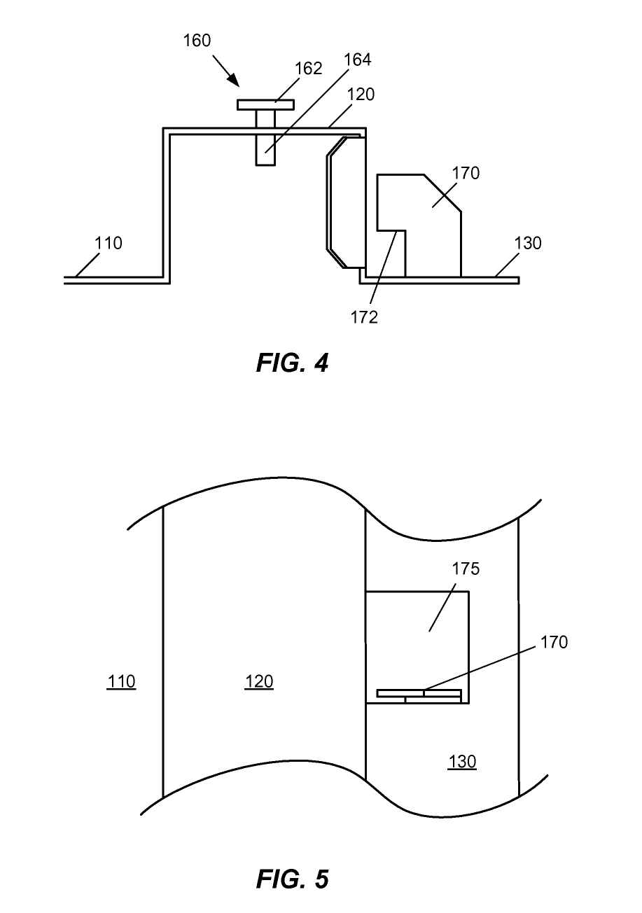

FIG. 4 is a magnified view of the encircled area labeled IV in FIG. 2. FIG. 4 shows that, in this example, adjustable leveler 160 has a head 162 and an adjustment portion 164 attached to head 162. Adjustment portion 164 interacts with an upper surface of elevated section 120 and is adjustable such that the elevation of head 162 can be changed relative to the elevation of the upper surface of elevated section 120 (and more importantly, changed relative to the elevation of the support surface or shelf). Each adjustable leveler 160 is adjustable in this manner and is adjustable independently of adjustments made to the other adjustable levelers 160. In other embodiments, one of the adjustable levelers 160 is replaced with a fixed post that is not adjustable. In this example, adjustment portion 164 is a threaded section that engages a threaded hole in the upper portion of elevated section 120. In this embodiment, a friction fit between the threads of adjustment portion 164 and the threads of the hole in elevated section 120 permits adjustment leveler 162 to remain in a chosen position without the use of a nut or other fixing member. While a threaded connection is used in this example, other relative adjustment devices and methods can alternatively be used. In FIGS. 1 and 3, head 162 is shown as an octagonal bolt head to facilitate adjustment by way of a standard wrench. Other embodiments can use a knurled surface on the edge of head 162 or other gripping arrangement that facilitate the adjustment of adjustable leveler 160. In this embodiment, head 162 has a smooth upper surface to permit the portions of the appliance that contact adjustable leveler 160 to easily slide over head 162.

Positioning bases in accordance with the invention provide easier leveling of an appliance installed in a cabinet because it is easier to adjust adjustable levelers 160 than is to adjust feet that are attached to the appliance itself. Built-in appliances such as, for example, ovens are often heavy and cumbersome. It can be very difficult to hold an appliance while adjusting feet that are attached to the appliance.

In some installations, it is important to install the appliance so that the appliance is level, regardless of whether the cabinet is level. In these cases, positioning bases in accordance with the invention greatly facilitate leveling the appliance. Referring to FIG. 1, a level can be placed across all different combinations of any two of the adjustable levelers 160 and the adjustable levelers 160 can be adjusted in order to provide a level base for the appliance. This procedure is far more simple, and requires less time, than the trial and error method that would be necessary with adjustable feet attached to the appliance itself.

Also shown in FIG. 4 is rail catch 170 which has a catch edge 172 that interacts with a rail mounted to the appliance.

FIG. 5 is a magnified view of the encircled area labeled V in FIG. 3. FIG. 5 shows rail catch 170 and a hole 175 in side section 130. In this example, hole 175 results from rail catch 170 being formed from material punched from side section 130.

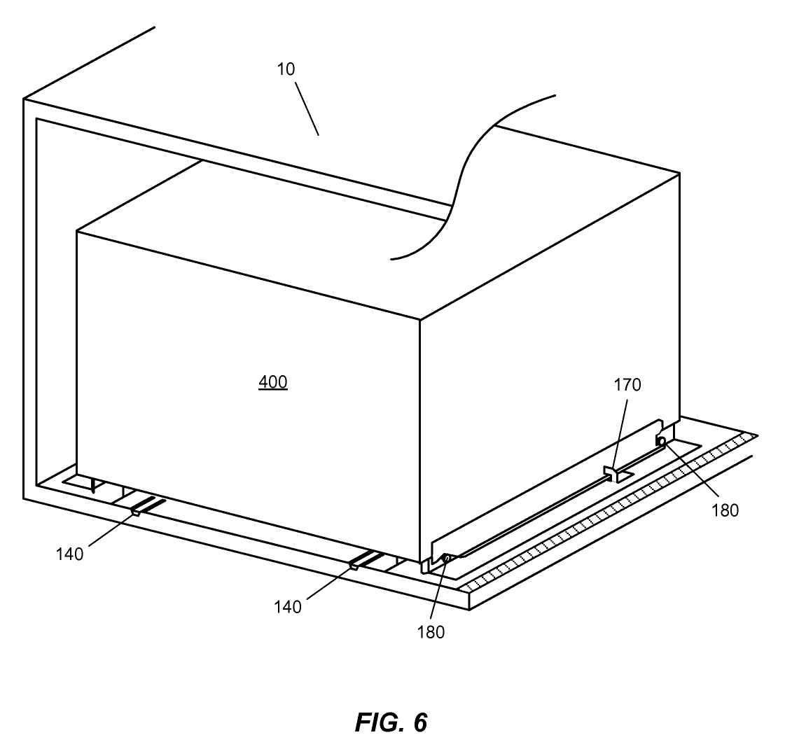

FIG. 6 shows an example of an appliance 400 in cabinet 10 in the installed position. In this example, appliance 400 is resting on four adjustable levelers 160.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the invention.

What is claimed is:

1. A positioning base for locating a household appliance in a cabinet, the base comprising:
a main body for attaching to a support area of the cabinet;
a first elevated section attached to the main body, an upper surface of the first elevated section being located vertically above the main body when the base is attached to the cabinet; and
a plurality of adjustable levelers attached to the upper surface of the first elevated section, each adjustable leveler having
a head for supporting the household appliance, and
an adjustment portion fixed to the head and movable relative to the upper surface of the first elevated section such that movement of the adjustment portion moves the head vertically relative to the upper surface of the first elevated section,
wherein the head of each of the adjustable levelers provides a resting point for a support point on the household appliance, and
each of the adjustable levelers is adjustable independently of each of the other adjustable levelers.

2. The base of claim 1, wherein the adjustment portion is a threaded portion that engages a threaded portion in the upper surface of the first elevated section.

3. The base of claim 1, wherein the base comprises four of the adjustable levelers.

4. The base of claim 3, wherein two of the adjustable levelers are attached to the first elevated section and two of the adjustable levelers are attached to a second elevated section having an upper surface.

5. The base of claim 3, wherein the adjustment portion is a threaded portion that engages a threaded portion in the upper surface of the first elevated section.

6. The base of claim 5, further comprising a locating feature for facilitating location of the base within the cabinet.

7. The base of claim 6, wherein the locating feature is a plurality of holes located in a portion of the main body that is adapted to rest on the support area of the cabinet, each hole being diamond shaped and being for positioning the base within the cabinet in a widthwise direction of the cabinet.

8. A cabinet for containing a household appliance, the cabinet comprising:
a cabinet body having an appliance receiving area; and
a positioning base positioned in the receiving area for locating the household appliance in the cabinet, the base having
a main body attached to a support area of the appliance receiving area;
a first elevated section attached to the main body, an upper surface of the first elevated section being located vertically above the main body; and
a plurality of adjustable levelers attached to the upper surface of the first elevated section, each adjustable leveler having
a head for supporting the household appliance, and
an adjustment portion fixed to the head and movable relative to the upper surface of the first elevated section such that movement of the adjustment portion moves the head vertically relative to the upper surface of the first elevated section,
wherein the head of each of the adjustable levelers provides a resting point for a support point on the household appliance, and
each adjustable leveler is adjustable independently of each of the other adjustable levelers.

9. The cabinet of claim 8, wherein the adjustment portion is a threaded portion that engages a threaded portion in the upper surface of the first elevated section.

10. The cabinet of claim 8, wherein the base comprises four of the adjustable levelers.

11. The base of claim 10, wherein two of the adjustable levelers are attached to the first elevated section and two of the adjustable levelers are attached to a second elevated section having an upper surface.

12. The cabinet of claim 10, wherein the adjustment portion is a threaded portion that engages a threaded portion in the upper surface of the first elevated section.

13. The cabinet of claim 12, further comprising a locating feature for facilitating location of the base within the cabinet.

14. The cabinet of claim 13, wherein the locating feature is a plurality of holes located in a portion of the main body that rests on the support area of the appliance receiving area, each hole being diamond shaped and being for positioning the base within the cabinet in a widthwise direction of the cabinet.

15. A cabinet/appliance combination comprising:
a household appliance; and
a cabinet, the cabinet having
a cabinet body having an appliance receiving area; and
a positioning base positioned in the receiving area, the base locating the household appliance in the cabinet, the base having
a main body attached to a support area of the appliance receiving area;
a first elevated section attached to the main body, an upper surface of the first elevated section being located vertically above the main body; and
a plurality of adjustable levelers attached to the upper surface of the first elevated section, each adjustable leveler having
a head that supports the household appliance, and
an adjustment portion fixed to the head and movable relative to the upper surface of the first elevated section such that movement of the adjustment portion moves the head vertically relative to the upper surface of the first elevated section,
wherein the head of each of the adjustable levelers provides a resting point that supports a support point on the household appliance, and
each adjustable leveler is adjustable independently of each of the other adjustable levelers.

16. The combination of claim 15, wherein the adjustment portion is a threaded portion that engages a threaded portion in the upper surface of the first elevated section.

17. The combination of claim 15, wherein the base comprises four of the adjustable levelers.

18. The combination of claim 17, wherein the adjustment portion is a threaded portion that engages a threaded portion in the upper surface of the elevated section.

19. The cabinet of claim 18, further comprising a locating feature for facilitating location of the base within the cabinet.

20. The cabinet of claim 19, wherein the locating feature is a plurality of holes located in a portion of the main body that rests on the support area of the appliance receiving area, each hole being diamond shaped and being for positioning the base within the cabinet in a widthwise direction of the cabinet.
